(19) United States
(12) Patent Application Publication
(10) Pub. No.: US 2008/0250810 A1
(43) Pub. Date: Oct. 16, 2008

(54) Cooling module applied for liquid containers

(75) Inventor: Chien-Jung Chen, Kaohsiung (TW)

Correspondence Address: Joe McKinney Muncy, PO Box 1364, Fairfax, VA, 22038-1364, US

(73) Assignee: Yen Sun Technology Corp.

(21) Appl. No.: 11/819,285

(22) Filed: Jun. 26, 2007

(30) Foreign Application Priority Data
Apr. 12, 2007 (TW) 96112871

(51) Int. Cl. B67D 5/00

(52) U.S. Cl. 62/396

(57) ABSTRACT

A cooling module applied for liquid containers comprises: A cooling pipeline forms with an inlet and an outlet for refrigerant to flow through. The liquid pipeline conducts liquids to flow through a thermal-exchanging matrix. The thermal-exchanging matrix is made from metals such as copper or aluminum. The cooling pipeline and liquid pipeline are both installed inside the thermal-exchanging matrix. The thermal-exchanging matrix is pre-cooled and therefore being kept at a predetermined temperature by the thermal controller. Consequently, through flown in and out of the thermal-exchanging matrix, the liquid is cooled down in short time and therefore kept at the predetermined temperature.

### BACKGROUND OF THE INVENTION

1. Field of the Invention

The present invention relates to a cooling module applied for liquid containers. More particularly, the present invention relates to pre-cool a thermal-exchanging matrix at a predetermined temperature so that the thermal energy of the liquid is absorbed into the thermal-exchanging matrix in short time. Consequently, the cooling efficiency of the liquid is improved.

2. Description of the Related Art

As can be seen in FIG. 1, a conventional cooling module applied for liquids includes a thermal-exchanging pipeline 7, an inlet joint 8, and an outlet joint 9. One end of the thermal-exchanging pipeline 7 connects to the inlet joint 8, and the other end of the thermal-exchanging pipeline 7 connects to the outlet joint 9. The thermal-exchanging pipeline 7 equips with an inner pipeline 71 and an outer pipeline 72, thereby, the inner pipeline 71 inside the outer pipeline 72 to commonly constitute the thermal-exchanging pipeline 7. The inner pipeline 71 is made from stainless steel and employed for the transmission of a liquid between the inlet joint 8 and the outlet joint 9. The outer pipeline 72 is made from copper or aluminum employed to accommodate the inner pipeline 72 and a refrigerant to facilitate the thermal exchanging between the refrigerant and the liquid. The inlet joint 8 forms with a liquid inlet 81 and a refrigerant inlet 82. The liquid inlet 81 connects to one end of the inner pipeline 71 by which conducts the liquid into the inner pipeline 71 and the refrigerant inlet 82 connects to one end of the outer pipeline 72. Eventually, the refrigerant is conducted into the passageway delimiting the space in between the inner pipeline 71 and the outer pipeline 72. Further, the outlet joint 9 forms with a liquid outlet 91 and a refrigerant outlet 92 for recycling the refrigerant. The liquid outlet 91 connects to the other end of the inner pipeline 71 further from the end connected to the liquid inlet 81. The liquid outlet 91 is adopted to lead out the liquid through thermal exchanging. The refrigerant outlet 92 connects to the other end of the outer pipeline 72 further from the end connected to the refrigerant inlet 82 adopted to outwardly connect to the pipeline of a compressor (not labeled), in use, the compressed refrigerant will be collected for recycling it. The conventional cooling module applied for liquids is used to be applied for a cool liquid dispenser or cool drink dispenser anyway (not labeled), in use, the refrigerant and the liquid put in the inner pipeline 71 and outer pipeline 72 at the very beginning by way of the liquid inlet 81 and the refrigerant inlet 82 respectively. Inside thermal-exchanging pipeline 7, the refrigerant absorbs the thermal energy of the liquid by thermal conduction to lower the liquid temperature. Subsequently, the liquid outlet 91 lead out the cool liquid for drinking, meanwhile the refrigerant outlet 92 conducts the refrigerant to flow through the pipelines for recycling it.

However, in operation, the thermal-exchanging pipeline thermal-exchanging pipeline 7 is used to wind into a smaller size for being housed inside the cool beverage dispenser or cool drink dispenser anyway, owing to that the flexibility of materials of the outer pipeline 72 (i.e. copper or aluminum) is greater than that of the inner pipeline 71 (i.e. stainless steel) introduces the issues the inner pipeline 71 being more difficult than the outer pipeline 72 in forming the same curvature, and therefore cracked at the turning area. As a result, the refrigerant will pollute the liquid via the cracks of the inner pipeline 71 the inner pipeline 71 and therefore poison the drinker in danger. Further, the inner pipeline 71 is completely surrounded by the outer pipeline 72 in improving thermal exchanging efficiency between the liquid and refrigerant thermal exchanging efficiency. Notwithstanding, the outer circumference of the outer pipeline 72 contacts with the atmosphere in whole in that the refrigerant inside the outer pipeline 72 keeps exchanging thermal energy with the atmosphere incessantly incapable of lowering the temperature efficiently and a great amount of energy loss. Based on the discussion above, there should be some improvement done for the conventional cooling module applied for liquids indeed.

Consequently, the present application did remove all those drawbacks hereinabove, the cooling pipeline and liquid pipeline both are embedded and installed inside the thermal-exchanging matrix. The cooling pipeline allows refrigerants to flow through. The liquid pipeline conducts liquids to flow through, and the thermal-exchanging matrix is pre-cooled, being kept at a predetermined temperature “a” by means of the thermal sensor to monitor and keep the temperature of the thermal-exchanging matrix for absorbing the thermal energy of the liquid, and then cool down the liquids by which flow through the thermal-exchanging matrix to shorten the time to cool the liquid. Further, the cooling pipeline and liquid pipeline never contact or connect to each other anyway being free from a refrigerant leakage and therefore polluted the liquid, as a result, the cooling efficiency and safe drinking of the liquid are enhanced.

### SUMMARY OF THE INVENTION

The primary objective of this invention is to provide a cooling module applied for liquid containers. The cooling pipeline and liquid pipeline both are embedded and installed inside the thermal-exchanging matrix, and the thermal-exchanging matrix is pre-cooled, being kept at a predetermined temperature “a” by means of the thermal sensor and the thermal controller. Consequently, a greatly improved thermal exchanging efficiency and low energy loss of the liquid is fulfilled.

The secondary objective of this invention is to provide a cooling module applied for liquid containers. The cooling pipeline and liquid pipeline are installed and embedded inside the thermal exchanging matrix respectively and never contact or connect to each other anyway being free from a refrigerant leakage and therefore not polluted the liquid inside the cooling pipeline. This results in a great liquid quality and safety for drinking.

Another objective of this invention is to provide a cooling module applied for liquid containers. The cooling pipeline and liquid pipeline are entirely wrapped up inside the thermal exchanging matrix respectively. Accordingly, the cooling pipeline and the liquid pipeline can't make thermal exchanging with the atmosphere in a way directly. Consequently, a greatly improved thermal exchanging efficiency and low energy loss of the liquid is achieved.

The beverage heating method in accordance with an aspect of the present invention includes a cooling pipeline, a liquid pipeline, a thermal-exchanging matrix, a thermal sensor and a thermal controller. A cooling pipeline, formed with an inlet and an outlet for refrigerants to flow through. A liquid pipeline conducts liquids to flow through the thermal-exchanging matrix. The thermal-exchanging matrix is made from metals with high thermal conductivities, installed and embedded inside the thermal-exchanging matrix the cooling pipeline and liquid pipeline both. The thermal sensor is attached upon an outer circumference of the thermal-exchanging matrix. The thermal controller is electrically connected to the thermal sensor. Consequently, the liquids is cooled down by which flow through the thermal-exchanging matrix in short time by means of the thermal sensor to monitor and keep the temperature of the thermal-exchanging matrix for absorbing the thermal energy of the liquid.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a perspective view illustrating a conventional cooling module applied for liquid containers in accordance with the prior art;

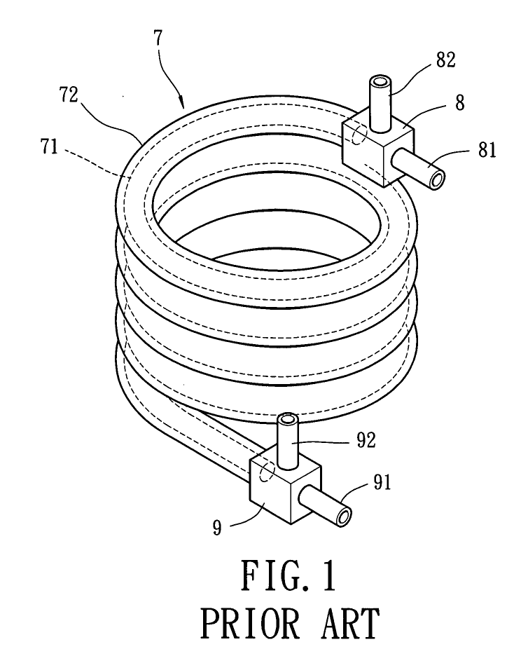

FIG. 2 is a perspective view illustrating a cooling module applied for liquid containers in accordance with a first embodiment of the present invention;

FIG. 3 is a cross-sectional view illustrating a cooling module applied for liquid containers in accordance with a first embodiment of the present invention; and

FIG. 4 is a cross-sectional view illustrating a cooling module applied for liquid containers in accordance with a second embodiment of the present invention.

### DETAILED DESCRIPTION OF THE INVENTION

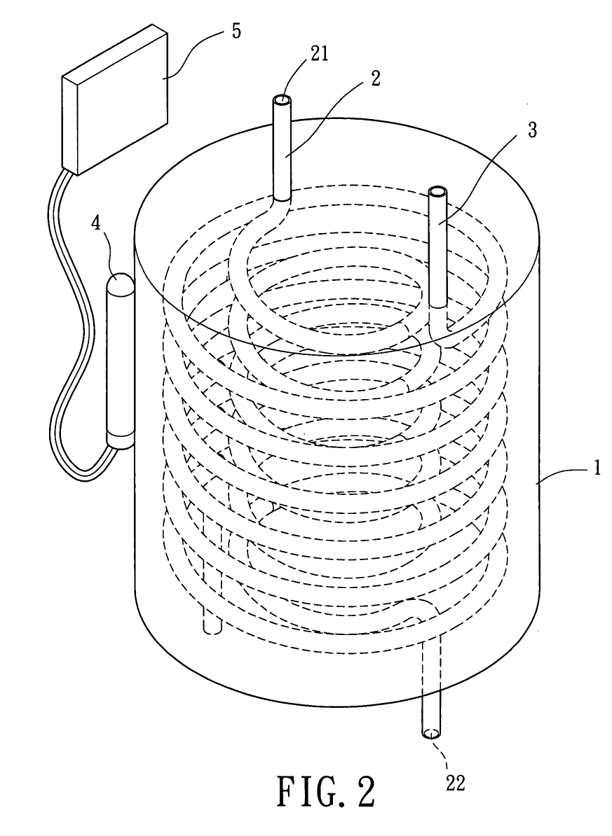

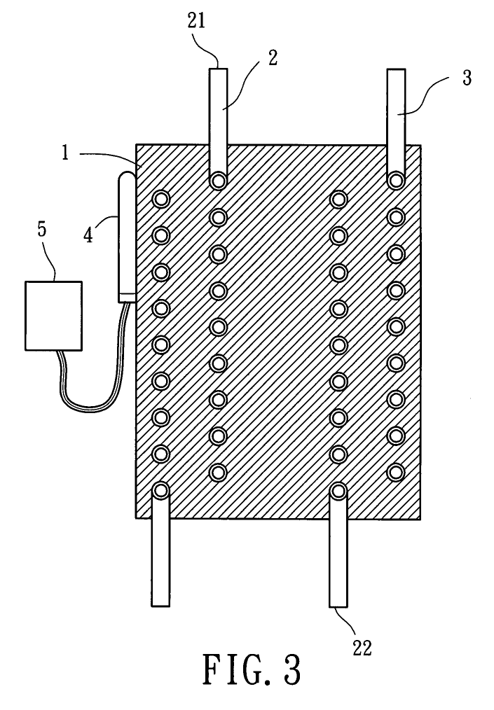

Referring now to FIG. 2 and 3, The cooling module applied for liquid containers in accordance with a first embodiment of the present invention is preferably applied for a cool beverage dispenser or cool drink dispenser, however, it can be further applied for various thermal exchanging apparatus, and details omitted herein.

Referring again to FIG. 2 and 3, the cooling module applied for liquid containers in accordance with a first embodiment of the present invention includes a thermal-exchanging matrix 1, a cooling pipeline 2, a liquid pipeline 3, a thermal sensor 4 and a thermal controller 5. The thermal-exchanging matrix 1 is made from materials with high thermal conductivities (for example: copper, aluminum or alloys thereof). The figure of the thermal-exchanging matrix 1 in cross-sectional view can be a circle, rectangular or others. The cooling pipeline 2 and liquid pipeline 3 both install inside the thermal-exchanging matrix 1. The thermal sensor 4 contacts with the thermal-exchanging matrix 1. The thermal controller 5 electrically connects to the thermal sensor 4 in order to detect the temperature of the thermal-exchanging matrix 1 to see whether over the set limit or not. Consequently, the thermal controller 5 enables the control of the temperature of the thermal-exchanging matrix 1.

Still referring to FIG. 2 and 3, the cooling pipeline 2 allows refrigerants to flow through. The liquid pipeline 3 conducts liquids to flow through. A compressor (not labeled) connects to the inlet 21 and the outlet 22 of the cooling pipeline 2 likewise. Once through thermal exchanging, the refrigerant is led out and then return to the refrigerant compressor via the refrigerant outlet 22. The refrigerant compressor compresses the refrigerant back to the cooling pipeline 2 via the refrigerant inlet 21 for recycling it to ensure the thermal-exchanging matrix 1 kept at a low temperature. The cooling pipeline 2 is formed with substantially circles pied up one another as a spiral inside the thermal-exchanging matrix 1 in a longitudinal direction on account of increasing the contacting area for thermal exchanging between the cooling pipeline 2 and the thermal-exchanging matrix 1 to further improve the thermal exchanging efficiency. Besides, the thermal controller 5 electrically connects to a refrigerant compressor in that the thermal sensor 4 is capable to control the refrigerant compressor via the thermal controller 5.

With continued reference to FIGS. 2 and 3, the liquid pipeline conducts liquids to flow through the liquid pipeline is formed with substantially circles pied up one another as a spiral embedded inside the thermal-exchanging matrix in a longitudinal direction, and the liquid pipeline 3 can be selectively set inside the cooling pipeline 2 or outside the cooling pipeline 2 and therefore surrounding the cooling pipeline 2 in a spiral manner, the shape of the both configuration being formed with substantially concentric circles in cross-sectional view.

Referring again to FIGS. 2 and 3, the cooling module applied for liquid containers in accordance with a first embodiment of the present invention, first the thermal-exchanging matrix 1 is pre-cooled, being kept at a predetermined temperature “a” by making use of the refrigerants, and then cool down the liquids by which flow through the thermal-exchanging matrix 1 at a predetermined temperature “a” in short time. In more details, before entering the thermal-exchanging matrix 1, the liquid is capable of absorbing the thermal energy of the thermal-exchanging matrix 1 constantly by means of the thermal controller 5 to start the compressor to circulate the refrigerant inside the cooling pipeline 2 until the thermal-exchanging matrix 1 cooled down at the temperature “a”. However, the temperature is lower than the temperature of the liquid, consequently, the liquid flows through the liquid pipeline 3 in that the liquid and the thermal-exchanging matrix 1 are capable of exchanging thermal energy via the liquid pipeline 3. On account of the temperature of the liquid higher than that of the thermal-exchanging matrix 1. The thermal-exchanging matrix 1 absorbs the thermal energy for lowering the temperature of the liquid at the temperature “a”.

With continued reference to FIG. 2 and 3, the thermal sensor incessantly detects the temperature of the thermal-exchanging matrix 1. The thermal sensor 4 electrically connects to the thermal controller 5. If the temperature of the thermal-exchanging matrix 1 is lower than a predetermined lower limit of the temperature “a” (i.e. over a predetermined range of the temperature “a”),the thermal sensor 4 deliver one signal to the thermal controller 5 to stop the recycling of the refrigerant inside the cooling pipeline 2 to avoid the thermal-exchanging matrix 1 at an unexpected over-lower temperature, and therefore introduce a low energy loss. In reverse, if the temperature of the thermal-exchanging matrix 1 is higher than a predetermined upper limit of the temperature a (i.e. over a predetermined range of the temperature “a”), the thermal sensor 4 deliver the other signal to the thermal controller 5 to incessantly cool the refrigerant inside the cooling pipeline 2 to avoid the thermal-exchanging matrix 1 at an unexpected over-high temperature for lowering the temperature of the liquid at the temperature “a”.

Referring again to FIGS. 2 and 3, once the liquid is selected to be a beverage, the materials of the liquid pipeline 3 is selected from an oxidation-proof metal embedded inside the thermal-exchanging matrix 1 so as to the prevent from the liquid being directly rinsing and flushing against the inner circumference of the thermal-exchanging matrix 1. Therefore, it is understood that the materials of the liquid pipeline 3 is so provided above-mentioned for the purpose as to free from the heavy metal components of the thermal-exchanging matrix 1 to pollute the liquid and introduce a mindless drinking to damage the drinker.

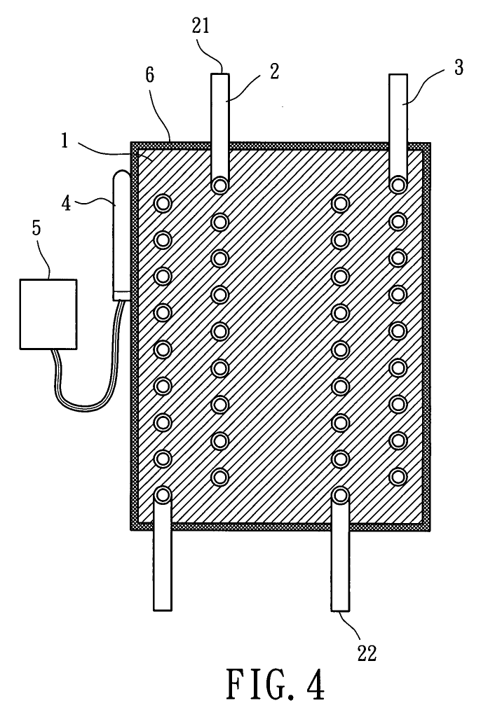

Further, turning now to FIG. 4, the thermal-exchanging matrix 1 is surrounded by an adiabatic unit(for example: fiberglass wool or poly-styrene) or selectively surrounded by an adiabatic vacuum unit (not labeled, for example: vacuum glass spacer), so configured as to reduce make unappreciated thermal exchanging with the outer environment of the atmosphere.

As explained above, in comparison with the conventional cooling module applied for liquids. Further, the inner pipeline 71 is completely surrounded by the outer pipeline 72. Notwithstanding, the outer circumference of the outer pipeline 72 directly contacts with the atmosphere in whole causing a great amount of energy loss. Referring back to FIG. 2, the cooling pipeline 2 and liquid pipeline 3 both are embedded and installed inside the thermal-exchanging matrix 1. The thermal-exchanging matrix 1 is pre-cooled, being kept at a predetermined temperature “a” by means of the thermal sensor 4 to monitor and keep the temperature of the thermal-exchanging matrix 1 for absorbing the thermal energy of the liquid, and then cool down the liquids by which flow through the thermal-exchanging matrix 1 by way of the liquid pipeline 3 in short time. As a result, the cooling efficiency is enhanced.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A cooling module applied for liquid containers comprising:
a cooling pipeline, formed with an inlet and an outlet for refrigerants to flow through;
a liquid pipeline, conducting liquids to flow through;
a thermal-exchanging matrix, made from metals, installed inside the thermal-exchanging matrix with both the cooling pipeline and liquid pipeline;
a thermal sensor, attached upon an outer circumference of the thermal-exchanging matrix; and
a thermal controller, electrically connected to the thermal sensor so that the thermal controller enables control of the refrigerants to circulate and flow through the cooling pipeline by making use of the thermal sensor;
wherein the thermal-exchanging matrix is pre-cooled, being kept at a predetermined temperature by making use of the thermal controller and the thermal sensor, and then cool down the liquids by which flow through the thermal-exchanging matrix in short time.

2. The cooling module applied for liquid containers as defined in claim 1, wherein the thermal controller electrically connects to a refrigerant compressor, the compressor connects to the inlet and the outlet of the cooling pipeline likewise in that the thermal sensor is capable to control the refrigerant compressor via the thermal controller.

3. The cooling module applied for liquid containers as defined in claim 1, wherein materials of the liquid pipeline is selected from an oxidation-proof metal to keep the liquids from the thermal-exchanging matrix.

4. The cooling module applied for liquid containers as defined in claim 1, wherein the cooling pipeline and the liquid pipeline is formed with substantially circles pied up one another as a spiral embedded inside the thermal-exchanging matrix in a longitudinal direction.

5. The cooling module applied for liquid containers as defined in claim 1, wherein the thermal-exchanging matrix is surrounded by an adiabatic unit.

6. The cooling module applied for liquid containers as defined in claim 1, wherein the thermal-exchanging matrix is surrounded by an adiabatic vacuum unit.

7. The cooling module applied for liquid containers as defined in claim 1, wherein the thermal-exchanging matrix is made from copper, aluminum or alloys thereof.
